(19) United States
(12) Patent Application Publication
(10) Pub. No.: US 2013/0115512 A1
(43) Pub. Date: May 9, 2013

(54) BUCKLED SILICON NANOSTRUCTURES ON ELASTOMERIC SUBSTRATES FOR RECHARGEABLE LITHIUM ION BATTERIES

(71) Applicants: Hanqing Jiang, Chandler, AZ (US); Cunjiang Yu, Champaign, IL (US); Bingqing Wei, Newark, DE (US)

(72) Inventors: Hanqing Jiang, Chandler, AZ (US); Cunjiang Yu, Champaign, IL (US); Bingqing Wei, Newark, DE (US)

(73) Assignees: University of Delaware, Newark, DE (US); Arizona Board of Regents for and on Behalf of Arizona State University, Scottsdale, AZ (US)

(21) Appl. No.: 13/583,938

(22) PCT Filed: Mar. 14, 2011
(86) PCT No.: PCT/US11/28271

§ 371 Date: Dec. 20, 2012

Related U.S. Application Data
(63) Continuation of application No. 61/313,688, filed on Mar. 12, 2010.

(51) Int. Cl. H01M 4/38; H01M 4/04

(52) U.S. Cl. CPC H01M 4/386; H01M 4/04
USPC 429/211; 216/13

(57) ABSTRACT

A flexible silicon anode includes a flexible substrate, a layer of silicon with a thickness of 1 μm or less adhered to the flexible substrate, and a current collector in contact with the layer of silicon. A lithium ion battery cell includes a flexible silicon anode, a current collector in contact with the layer of silicon; a lithium cathode; a separator between the silicon anode and the lithium cathode; an electrolyte in contact with the silicon anode and the lithium cathode; and an electrical connection between the silicon anode and the lithium cathode. Forming the flexible silicon anode can include etching a silicon-on-insulator structure to form a silicon layer on the silicon substrate, treating the silicon layer, contacting the treated silicon layer with a flexible substrate, and separating the flexible substrate and the silicon substrate, thereby transferring the treated silicon layer from the silicon substrate to the flexible substrate.

### TECHNICAL FIELD

The present invention relates to rechargeable battery technologies and applications.

### BACKGROUND

Rechargeable batteries are high-energy storage devices that may become a primary power source for modern day power needs. For example, next generation lithium (Li) ion batteries may soon be implemented to have higher energy capacity and longer cycle life for applications in portable electronic devices, satellites, and electric vehicles. Silicon (Si) is an attractive anode material for use in lithium ion batteries because of its highest-known theoretical charge capacity of 4,200 mAh/g².

Interestingly, a large volumetric change (400%) of silicon anodes upon insertion and extraction of lithium (each silicon atom can accommodate 4.4 lithium atoms leading to the formation of Li₂₂Si₅ alloy) can result in pulverization and early capacity fading in silicon anode lithium ion batteries. FIG. 1A depicts diffusion of lithium ions into silicon anode 10 having silicon 11 on rigid substrate 12. FIG. 1B depicts the result of a large volumetric change and introduction of cracks in silicon 11, resulting in fractured silicon 13.

### SUMMARY

In one aspect, a silicon anode includes a flexible substrate, a layer of silicon with a thickness of 1 μm or less adhered to the flexible substrate, and a current collector in contact with the layer of silicon.

In another aspect, a lithium ion battery cell includes a silicon anode having a flexible substrate, a layer of silicon with a thickness of 1 μm or less adhered to the flexible substrate, and a current collector in contact with the layer of silicon; a lithium cathode; a separator between the silicon anode and the lithium cathode; an electrolyte in contact with the silicon anode and the lithium cathode; and an electrical connection between the silicon anode and the lithium cathode.

In another aspect, forming a silicon anode includes etching a silicon-on-insulator structure to form a silicon layer having a thickness of 1 μm or less on the silicon substrate, treating the silicon layer, contacting the treated silicon layer with a flexible substrate to adhere the treated silicon layer to the flexible substrate, and separating the flexible substrate and the silicon substrate, thereby transferring the treated silicon layer from the silicon substrate to the flexible substrate to form a flexible silicon anode.

Implementations can include one or more of the following features, separately or in any combination.

The silicon layer adhered to the flexible substrate may include a multiplicity of unidirectional silicon nanostructures adhered to the surface of the flexible substrate, a multiplicity of bidirectional silicon nanostructures adhered to the surface of the flexible substrate, or a silicon membrane adhered to the surface of the flexible substrate. In some cases, the silicon layer adhered to the flexible substrate is flat or planar. In other cases, the silicon layer adhered to the flexible substrate is buckled or wavy. A width or a length of the silicon layer may be at least 100 or 1000 times the thickness of the silicon layer. The silicon layer may be doped or undoped, and may be crystalline, polycrystalline, or amorphous.

The flexible substrate may include or consist of poly(dimethylsiloxane). A thickness of the flexible substrate can be at least 100 times or up to 1000 or 10,000 times the thickness of the silicon layer. In some cases, the current collector includes a layer of metal between the flexible substrate and the silicon layer. In certain cases, the current collector is formed over a portion of the silicon layer.

In some cases, etching the silicon-on-insulator structure includes removing an insulator layer between the silicon layer and the silicon substrate. The silicon layer may not be adhered to the silicon substrate. Treating the silicon layer includes forming a current collector on the silicon layer and forming an adhesive layer on the current collector. In some cases, treating the silicon layer includes forming an adhesive layer on the silicon layer.

The flexible substrate may be stretched in at least one direction before contacting the treated silicon layer with the flexible substrate. In some cases, the flexible substrate is treated before contacting the treated silicon layer with the flexible substrate. Treating the flexible substrate may include irradiating the flexible substrate with ultraviolet radiation or exposing the flexible substrate to oxygen plasma. Treating the flexible substrate can include uniformly treating a surface of the flexible substrate or treating portions of a surface of a flexible substrate.

A flexible silicon anode as described herein may be laminated to a lithium cathode with a separator to form a lithium ion battery cell. A current collector may be formed on the silicon anode such that current collector contacts the silicon layer, and silicon anode can be laminated to a lithium cathode with a separator to form a lithium ion battery cell.

Flexible silicon anodes described herein can survive large volumetric strain and remain functional. Thus, the buckled silicon layers on flexible substrates can release the stress and relieve the failure of silicon in silicon anodes for lithium ion batteries.

Thus, particular embodiments have been described. Variations, modifications, and enhancements of the described embodiments and other embodiments can be made based on what is described and illustrated. In addition, one or more features of one or more embodiments may be combined. The details of one or more implementations and various features and aspects are set forth in the accompanying drawings, the description, and the claims below.

### BRIEF DESCRIPTION OF THE DRAWINGS

FIGS. 1A and 1B depict a large volumetric change and stress-induced cracks in a rigid silicon anode upon insertion of lithium.

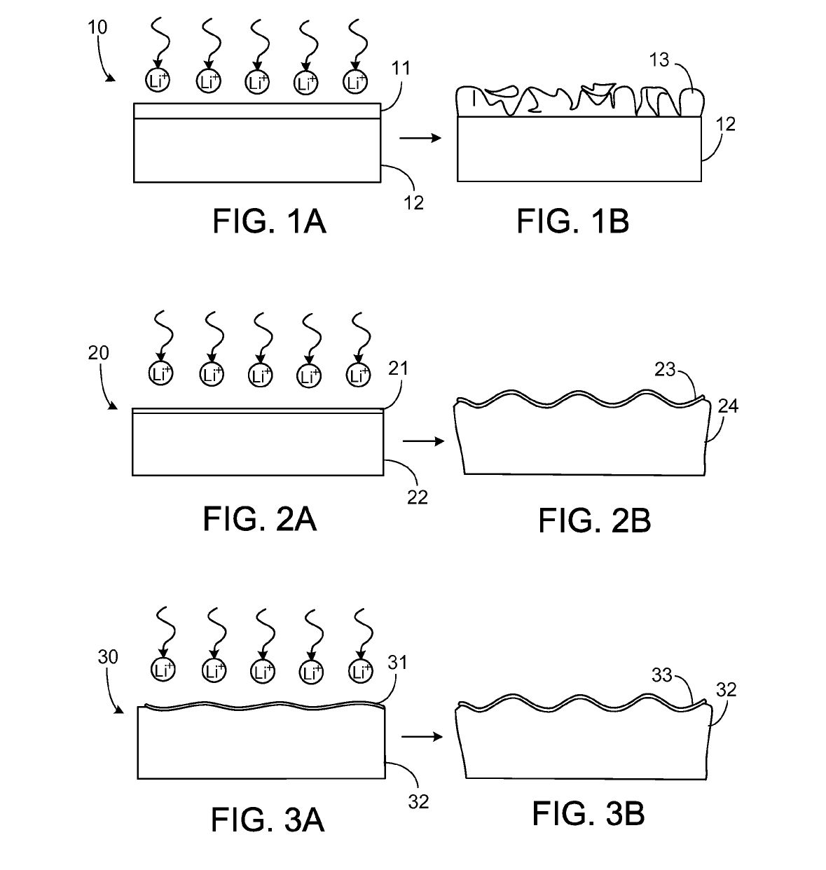

FIGS. 2A and 2B depict release of diffusion-induced stress in a silicon anode by buckling of initially flat silicon on a flexible substrate upon insertion of lithium.

FIGS. 3A and 3B depict release of diffusion-induced stress in a silicon anode by a change in buckling profile of initially buckled silicon on a flexible substrate upon insertion of lithium.

FIGS. 4A-4E depict fabrication of a flexible silicon anode with buckled silicon nanostructures.

FIGS. 5A-5D depict fabrication of a flexible silicon anode with flat silicon nanostructures.

FIGS. 6A-6K depict fabrication of flexible silicon anodes with buckled silicon nanostructures formed with patterned and unpatterned flexible substrates.

FIGS. 7A-7C show images of buckled silicon nanostructures on flexible substrates.

FIG. 8 is a flowchart showing steps in a process for forming a flexible silicon anode.

FIG. 9 depicts a lithium ion battery.

FIG. 10A depicts a lithium ion battery cell having a silicon anode with a buckled silicon nanostructures. FIG. 10B depicts a lithium ion battery cell having a silicon anode with initially flat silicon nanostructures.

FIG. 11 shows an X-ray diffraction spectrum of doped silicon.

FIGS. 12A-12B show specific capacity for lithium ion batteries having silicon anodes with buckled silicon nanostructures.

FIG. 13 A is an image of a flat silicon nanostructure in a flexible silicon anode before charge. FIG. 13B is an image of the buckled silicon nanostructure resulting from one charge cycle of the flat silicon nanostructure shown in FIG. 13A.

FIGS. 14A-14C depict steps in a process to form a poly-silicon-on-insulator or amorphous-silicon-on-insulator structure.

FIG. 15A shows an SEM image of a poly-SOI structure. FIG. 15B shows an image of flat poly-silicon nanostructures on a PDMS substrate. FIGS. 15C and 15D show images of buckled silicon nanostructures on PDMS substrates.

### DETAILED DESCRIPTION

As described herein, mechanically compliant silicon nanostructures can be adhered to flexible substrates to form anodes capable of releasing stress induced by lithium ion diffusion and volumetric changes in the silicon during charge-discharge cycles in a lithium ion battery. Buckled or wavy-shaped silicon nanostructures in a flexible silicon anode can release the strain by a change in buckling profile when the anode is subjected to diffusion-induced stress that occurs during charge-discharge cycles in a lithium ion battery. Thus, the silicon is not directly strained, and intrinsic fracture is reduced or avoided, extending the cycle life of the anode. The flexible silicon morphology described herein has been shown to bear up to 150% strain without failure. In addition, high energy density can be realized.

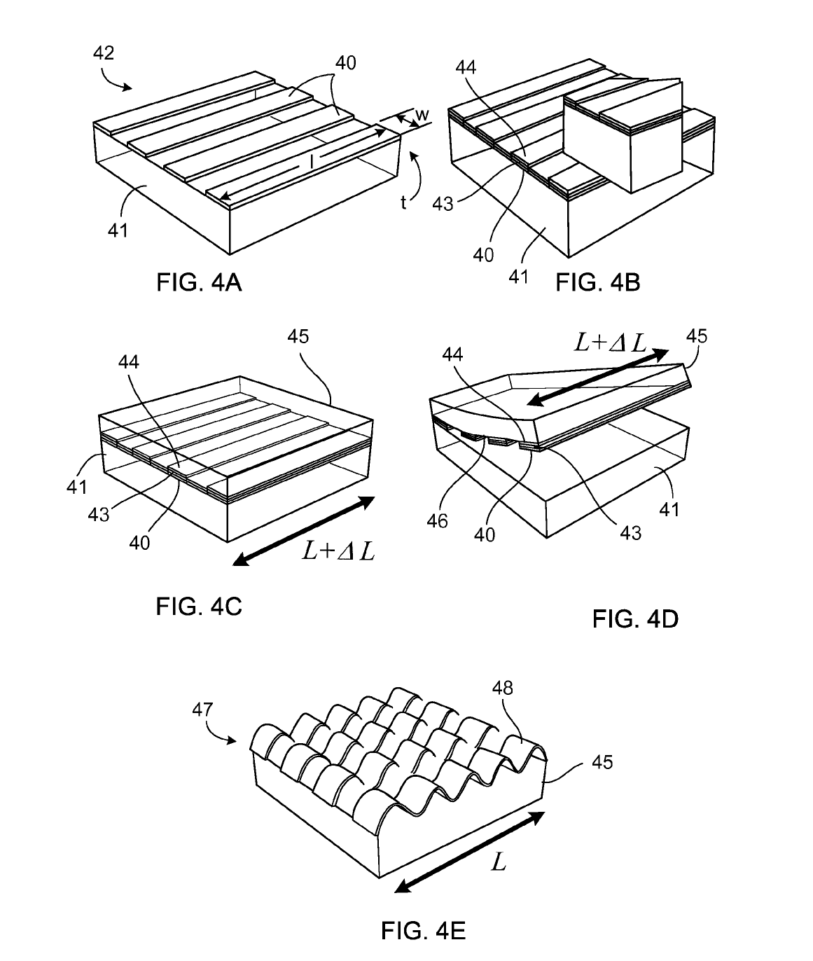

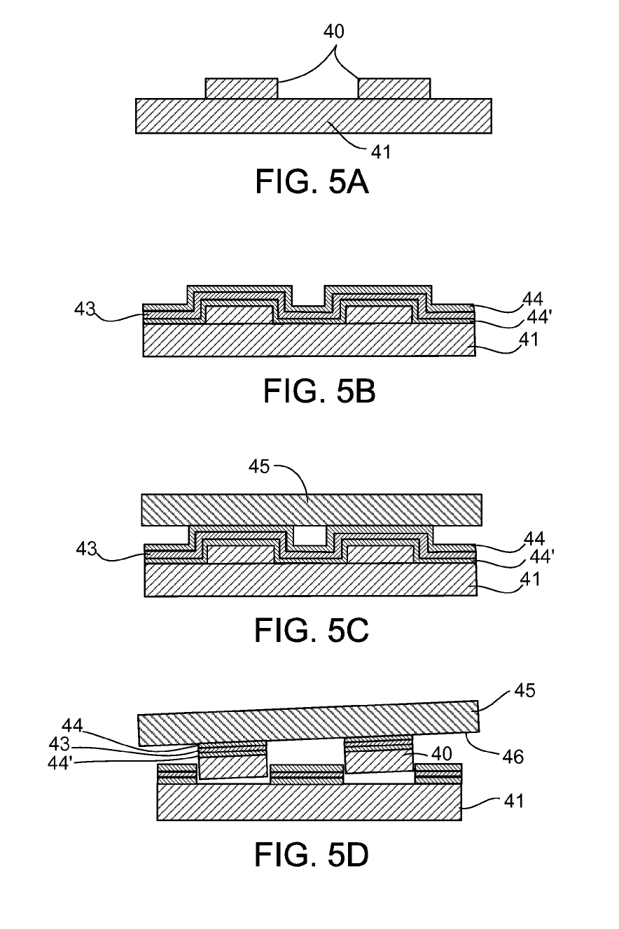

FIGS. 2A-2B and 3A-3B depict diffusion of lithium ions into silicon anodes with flexible substrates. FIG. 2A shows lithium ion diffusion into flexible silicon anode 20. Flexible silicon anode 20 has initially flat silicon layer 21 on flexible substrate 22. As the lithium ions diffuse into flexible silicon anode 20, diffusion-induced stress in silicon layer 21 deforms flexible substrate 22 and the silicon buckles to release the stress in the silicon. Buckled silicon layer 23 is shown on flexible substrate 24 in FIG. 2B. FIG. 3A shows lithium ion diffusion into flexible silicon anode 30. Flexible silicon anode 30 has initially buckled silicon layer 31 on flexible substrate 32. As the lithium ions diffuse into flexible silicon anode 30, diffusion-induced stress in silicon layer 31 deforms flexible substrate to release the stress in the silicon. The buckling profile of initially buckled silicon layer 31 changes as the stress is released to yield buckled silicon layer 33 on flexible substrate 32, as shown in FIG. 3B. Thus, in the embodiments shown in FIGS. 2A-2B and 3A-3B, the stress introduced by lithium ion diffusion during charge-discharge cycles is released through out-of-plane deformation of the silicon layer, thereby reducing fracture of the silicon layer and increasing the cycle life of the anode.

Flexible substrates 22 and 32 may be formed out of elastomeric material such as, for example, poly(dimethylsiloxane) (PDMS). Silicon layers 21 and 31 may be nanostructured, or may be in the form of a thin film or membrane on the flexible substrate. Nanostructured silicon can include, for example, silicon nanoribbons. The nanoribbons may be flat or buckled, and can be oriented in one or more directions on the flexible substrate. In some cases, a silicon layer has a thickness between less than about 1 μm (e.g., between about 50 nm and about 1 μm). The flexible substrate may have a thickness between about 100 μm and about 1 mm, or may be at least about 100 times or up to 1000 or 10,000 times thicker than the silicon layer. In an example, the silicon layer is about 100 nm thick and the flexible layer is about 100 μm thick.

When the silicon layers are subjected to a compressive strain along the longitudinal dimension, the structure may buckle to release the axial strain by lateral deformation. Thus, the driving energy to generate buckling of the silicon layer may be the strain energy from the compressive strain. In the formation of flexible silicon anodes, the strain energy stored in a pre-stretched flexible substrate can be the driving energy to trigger the buckling of the silicon layer. Once buckling occurs, the lateral deformation (buckling) of silicon may increase the bending energy, which can be proportional to the bending rigidity. Thus, the bending energy may be thought of as the resistance. In some cases, therefore, the use of thick flexible substrates for initial buckling, as depicted in FIGS. 2A-2B, may be advantageous. After the silicon layer has buckled, the strain energy stored in the buckled silicon layer due to the diffusion-induced strain is the driving energy. This energy can drive the change of the buckling profile and deform the flexible substrate, as shown in FIGS. 3A-3B. Thus, for post-buckling, a thick flexible substrate may result in fracture of the silicon layer rather than a change of buckling profile, and a thin flexible substrate may be more advantageous.

Flexible silicon anodes can be fabricated from the device layer of a silicon-on-insulator (SOI) structure, having an insulator layer disposed between a silicon substrate and a crystalline silicon layer. The crystalline silicon layer on the wafer may be initially doped (e.g., with boron to form a p-type silicon layer). In some cases, a process such as ion implantation or thermal annealing may be used to dope the silicon layer. The doped or undoped silicon layer can be used in the formation of a flexible silicon anode. In some cases, doped silicon can provide higher conductivity than undoped silicon. Thus, to realize high-energy and high-power density, as well as long-life cycling, it may be beneficial to use a doped silicon layer in a flexible silicon anode.

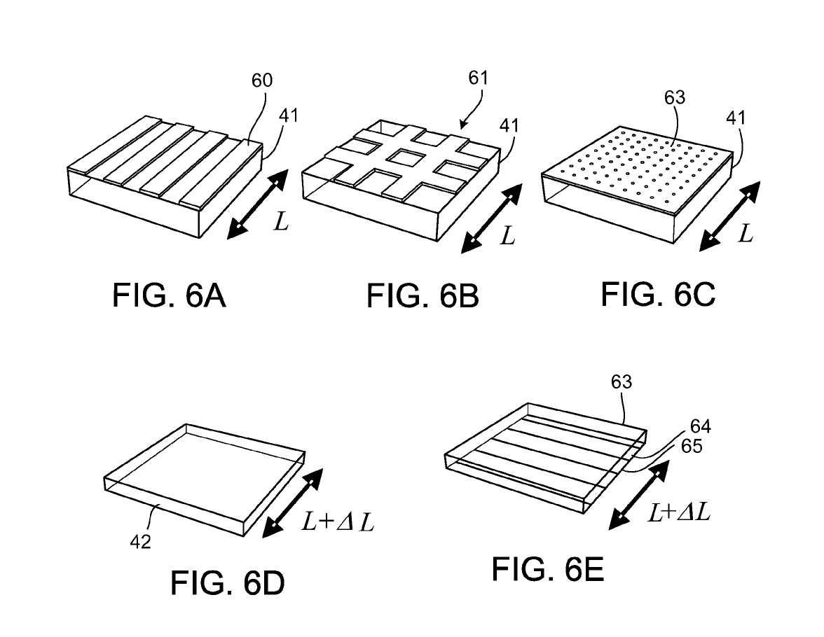

FIGS. 4A-4E depict formation of a flexible silicon anode having a buckled silicon layer on a flexible substrate. Referring to FIG. 4A, silicon nanostructures 40 having length l, width w, and thickness t are formed on silicon substrate 41 of SOI structure 42 using photolithographic and etching methods. In some cases, nanostructures 40 have various shapes and sizes. The etching may include, for example, under-cut etching using hydrofluoric acid to remove a buried insulator layer (e.g., silicon dioxide layer) of SOI structure 42. Thus, silicon nanostructures 40 rest on silicon substrate 41 of SOI structure 42 but are not adhered to the silicon substrate.

The thickness of silicon nanostructures can range up to about 1 μm, for example, from about 50 nm to about 1 μm. An adhesive layer, or a current collector and an adhesive layer, may be disposed on silicon nanostructures 40. FIG. 4B shows current collector 43 formed over silicon nanostructures 40. Current collector 43 may be, for example, gold, copper, aluminum, or other conductive metal. Adhesive layer 44 is formed over current collector 43. In one example, adhesive layer 44 is formed by depositing chromium on current collector 43, and then oxidizing the chromium with a plasma oxidation to form Cr₂O₃. In some cases, for example when silicon nanostructures 40 are doped, the silicon nanostructures are conducting, and adhesive layer 44 may be formed directly on the silicon nanostructures.

As shown in FIG. 4C, adhesive layer 44 is contacted with flexible substrate 45. To form a flexible anode having a wavy or buckled silicon layer, flexible substrate 45 of length L can be stretched a distance ΔL prior to contacting adhesive layer 44. In some cases, stretched flexible substrate 45 is aligned with silicon nanostructures 40 such that the direction in which the flexible substrate is stretched is aligned along a length l of the nanostructures. Although FIG. 4C depicts stretching of flexible substrate 45 in one direction, the flexible substrate can also be stretched in one or more additional directions. For example, the flexible substrate can be stretched in perpendicular directions, such that the directions in which the flexible substrate is stretched are aligned along a length l and along a width w of the nanostructures.

Surface 46 of flexible substrate 45 can be treated before or after the flexible substrate is stretched or before adhesive layer 44 is contacted with the flexible substrate. The treatment may be selected to enhance the formation of bonds (e.g., covalent bonds) between flexible substrate 45 and adhesive layer 44. In one example, surface 46 is treated with an ultraviolet/ozone (UVO) process to change surface properties of flexible substrate 45. In a UVO process, exposure of a flexible substrate such as PDMS to ultraviolet (UV) light introduces atomic oxygen (O), an activated species that can react with the flexible substrate to change a hydrophobic surface (dominated, for example, in PDMS by —OSi(CH₃)₂O— groups) to a hydrophilic surface (terminated with —OₙSi(OH)₄₋ₙ functionalities). In another example, a similar reaction occurs in an oxygen plasma process. The hydrophilic surface of PDMS is able to form strong chemical bonds through condensation reactions (at room temperature or as accelerated during baking at elevated temperatures) with various inorganic surfaces that have —OH groups. In an example, UVO treatment enhances the formation of —Si—O—Cr— bonds between a PDMS flexible substrate and a Cr₂O₃ adhesive layer.

Surface treatment of a flexible substrate can be uniform or patterned. Uniform surface treatment yields an unpatterned (or uniformly treated) surface on a flexible substrate. Patterned or selective surface treatment yields adhesive (treated) and non-adhesive (untreated) portions on the flexible substrates. The selective surface treatment can be realized by using a mask (e.g., a gold mask) during treatment (e.g., UVO treatment) of the flexible substrate, with treated (exposed) areas of the flexible substrate able to adhere to the silicon layer, and with untreated (masked) areas showing little or no adhesion to the silicon layer.

After contact (e.g., conformal contact) is made between made between flexible substrate 45 and adhesive layer 44 on nanostructures 40, the flexible substrate is separated from silicon substrate 41. As shown in FIG. 4D, silicon nanostructures 40 are transferred to flexible substrate 45, and adhered with adhesive layer 44. (Adhesive Current collector 43, when present, is between adhesive layer 44 and silicon nanostructures 40. Removing flexible substrate 45 from silicon substrate 41 releases strain in the flexible substrate, with silicon nanostructures 40 and flexible substrate 45 buckling to form flexible silicon anode 47. For simplicity, current collector 43 and adhesive layer 44 are not shown on silicon substrate in FIG. 4D. As shown in FIG. 4E, buckled silicon nanostructures 48 are adhered to flexible substrate 45, which is also buckled.

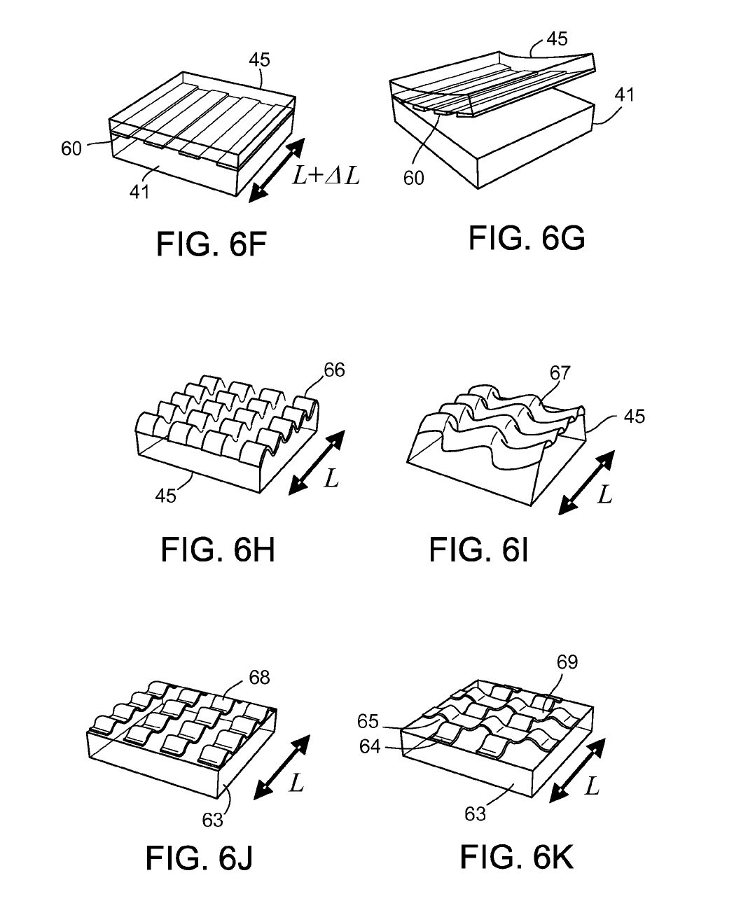

FIGS. 5A-5D depict formation of a flat silicon layer on a flexible substrate. FIG. 5A shows nanostructures 40 formed on silicon substrate 41 using photolithographic and etching methods to etch a SOI structure. The etching may include, for example, under-cut etching using hydrofluoric acid to remove a buried insulator layer (e.g., silicon dioxide layer) of the SOI structure. Thus, silicon nanostructures 40 rest on silicon substrate 41 but are not adhered (e.g., bonded) to the silicon substrate of the SOI structure. A first adhesive layer may be disposed on silicon nanostructures 40, a current collector may be disposed on the first adhesive layer, and a second adhesive layer may be disposed on the current collector. FIG. 5B shows first adhesive layer 44′, current collector 43, and second adhesive layer 44 formed over silicon nanostructures 40. Current collector 43 may be, for example, gold or copper. In one example, adhesive layers 44′ and 44 are formed by depositing chromium on silicon nanostructure 40 or current collector 43, respectively, and then oxidizing the chromium with a plasma oxidation to form Cr₂O₃.

As shown in FIG. 5C, adhesive layer 44 is contacted with flexible substrate 45. Flexible substrate 45 is not stretched before contacting with adhesive layer 44. In some cases, as described with respect to FIGS. 4A-4D, surface 46 of flexible substrate 45 is treated before adhesive layer 44 is contacted with the flexible substrate.

After contact is made between surface 46 of flexible substrate 45 and adhesive layer 44 on top of silicon nanostructures 40, the flexible substrate is separated from silicon substrate 41. As shown in FIG. 5D, silicon nanostructures 40 are transferred to flexible substrate 45, with adhesive layer 44 in contact with flexible substrate 45 and current collector 43 between the adhesive layer and the silicon nanostructures. Removing flexible substrate 45 from silicon substrate 41 yields flexible silicon anode 50 with flat silicon nanostructures 40 adhered to flexible substrate 45, and current collector 43 between the silicon nanostructures and the flexible substrate. As noted with respect to FIGS. 4A-4E, the current collector is optional. That is, in some cases, the silicon nanostructures may be adhered directly to the flexible substrate.

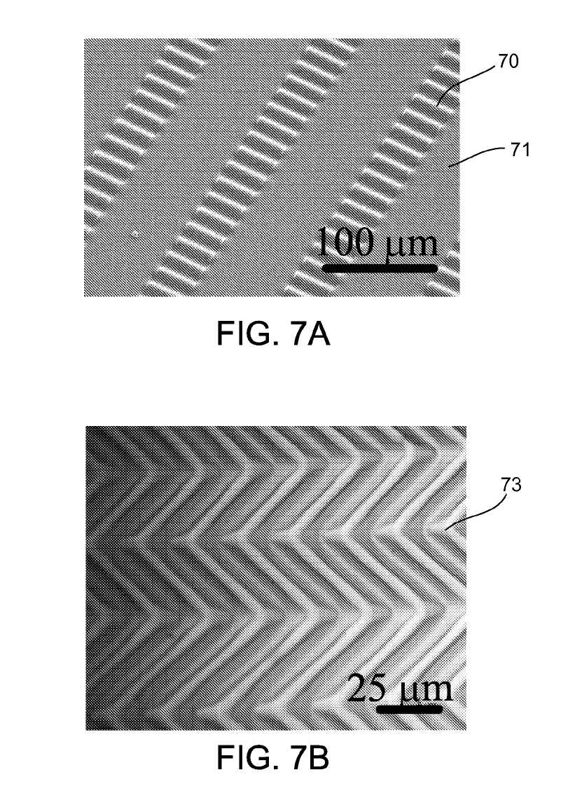

Flexible silicon anodes can be formed with other silicon layer morphologies and with selectively treated flexible substrates in processes similar to those described with respect to FIGS. 4A-4E and 5A-5D. FIGS. 6A-6K show selected steps in the fabrication of flexible silicon anodes formed with uniformly treated and selectively treated flexible substrates. FIGS. 6A, 6B, and 6C show silicon layers including unidirectional silicon nanostructures 60, bidirectional silicon nanostructures 61, and silicon film or nanomembrane 62, respectively, on silicon substrates 41. Similarly to the silicon nanostructures shown in FIG. 4A, these silicon layers have a thickness t, length l, and width w. Current collectors and/or adhesive layers, not shown here, may be applied to these silicon layers as described with respect to FIGS. 4A-4E and 5A-5D, if desired.

FIG. 6D shows a uniformly treated flexible substrate 45 of length L, stretched to length L+ΔL. Flexible substrate 45 may be treated as described with respect to FIGS. 4A-4E. FIG. 6E shows selectively treated flexible substrate 63 of length L, stretched to length L+ΔL. Flexible substrate 63 may patterned, for example, by a UVO surface treatment, with a UVO mask selected to form activated (or adhesive) regions 64 on the surface of the flexible substrate, leaving regions 65 unactivated (or non-adhesive). As shown in FIG. 6F, the silicon nanostructures (e.g., unidirectional silicon nanostructures 60) are contacted with stretched flexible substrate. Flexible substrate 45 is shown, but flexible substrate 63 could also be used. The flexible substrate is then separated from silicon substrate 41, as shown in FIG. 6G, releasing the pre-strain on the flexible substrate and forming buckled nanostructures. Surface treatment of the flexible substrate can be patterned to yield a desired buckling morphology. That is, the surface of the flexible substrate can be selectively treated to form adhesive regions on the flexible substrate, such that a silicon layer in contact with a treated region adheres to the treated region, but a silicon layer in contact with an untreated region shows little or no adhesion to untreated regions.

FIG. 6H shows buckled one-dimensional nanostructures 66 resulting from contact of nanostructures 60 in FIG. 6A with unpatterned (uniformly treated) flexible substrate 45. FIG. 6I shows buckled two-dimensional nanostructures 67 resulting from contact of two-dimensional nanostructures 61 with unpatterned (uniformly treated) flexible substrate 45. FIG. 6J shows controlled one-dimensional buckling of silicon nanostructures 60 to form buckled nanostructures 68 on flexible substrate 63, with the buckled nanostructures adhered to treated regions 64 of the flexible substrate and separated from the flexible substrate proximate untreated regions 65. FIG. 6K shows controlled two-dimensional buckling of silicon nanostructures 61 to form buckled nanostructures 69, with the buckled nanostructures adhered to treated regions 64 of the flexible substrate and separated from the flexible substrate proximate untreated regions 65

Flexible silicon anodes can also be formed as described with respect to FIGS. 6A-6K with unstretched flexible substrates, yielding initially unbuckled (or flat) silicon layers (e.g., nanostructures, films or membranes) on a flexible layer, an example of which is depicted in FIG. 5D.

In some cases, after fabrication of flexible silicon anodes such as those shown in FIGS. 6H-6K without current collectors between the silicon layer and the flexible substrate, current collectors can be formed on the anode, in contact with the silicon layer. In an example, current collectors in the form of metal strips can positioned at an edge of the anode, in contact with the silicon layer (e.g., silicon nanostructures)

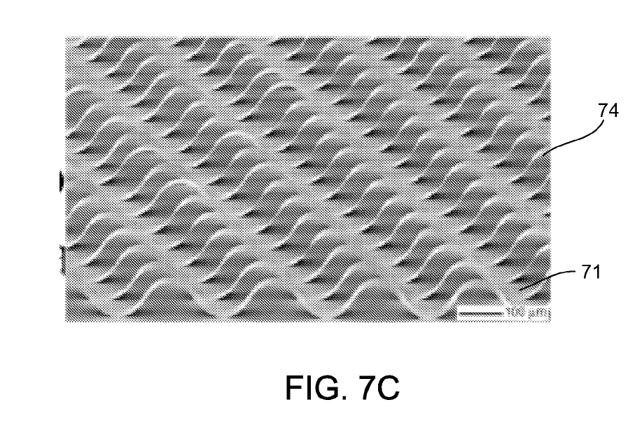

FIGS. 7A-7B show images of buckled silicon nanostructures on uniformly treated PDMS. FIG. 7A is an SEM image of unidirectional buckled 100 nm-thick silicon nanostructures 70 on uniformly treated PDMS substrate 71. The PDMS substrate was subjected to 7% pre-strain (one direction) during fabrication. The measured buckling wavelength for the buckled silicon in FIG. 7A is 17.2 μm. FIG. 7B is an optical image of buckled two-dimensional 100 nm-thick silicon nanostructure 73 on a PDMS substrate. The PDMS substrate was subjected to 7% pre-strain in two (perpendicular) directions during fabrication. FIG. 7C shows an image of buckled silicon nanostructures 74 on a patterned PDMS substrate, with treated and untreated regions formed in a masking process. Buckled silicon nanostructures 74 are partially and periodically bonded with the PDMS substrate.

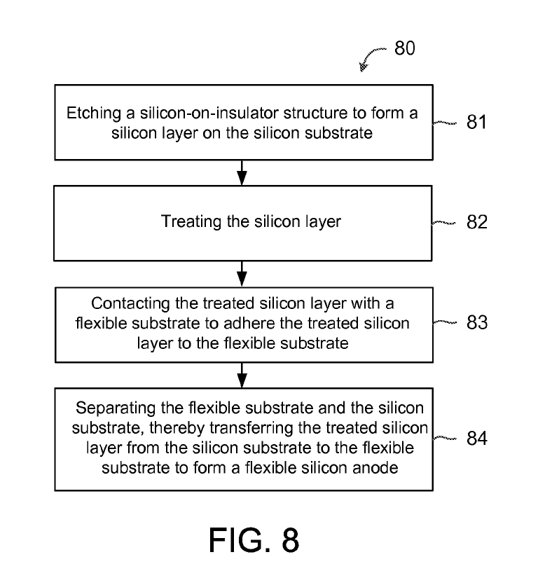

FIG. 8 is a flowchart showing steps in a process 80 to form a flexible silicon anode. Step 81 includes etching a SOI structure to form a silicon layer having a thickness of 1 μm or less on the silicon substrate. In some cases, etching the silicon-on-insulator structure includes removing an insulator layer of the SOI structure between the silicon layer and the silicon substrate. The silicon layer may be, for example, a multiplicity of unidirectional silicon nanostructures, a multiplicity of bidirectional silicon nanostructures, or a silicon membrane. The silicon layer is not adhered to the silicon substrate.

Step 82 includes treating the silicon layer. Treating the silicon layer can include forming a current collector on the silicon layer and forming an adhesive layer on the current collector. In some cases, treating the silicon layer includes forming an adhesive layer on the silicon layer.

Step 83 includes contacting the treated silicon layer with a flexible substrate to adhere the treated silicon layer to the flexible substrate. The flexible substrate may be, for example, PDMS. In some cases, the flexible substrate is stretched in at least one direction (e.g., in two perpendicular directions) before contacting the treated silicon layer with the flexible substrate. The flexible substrate may be treated (e.g., exposed to UV radiation) before contacting the treated silicon layer with the flexible substrate. The flexible substrate may be treated uniformly or selectively (e.g., with a mask) to form an unpatterned or patterned flexible substrate, respectively.

Step 84 includes separating the flexible substrate and the silicon substrate, thereby transferring the treated silicon layer from the silicon substrate to the flexible substrate to form a flexible silicon anode. The treated silicon layer, when adhered to the flexible substrate, may be planar or buckled. A current collector may be formed on the flexible silicon anode. In some cases, the flexible silicon anode is laminated to a lithium cathode with a separator to form a lithium ion battery cell.

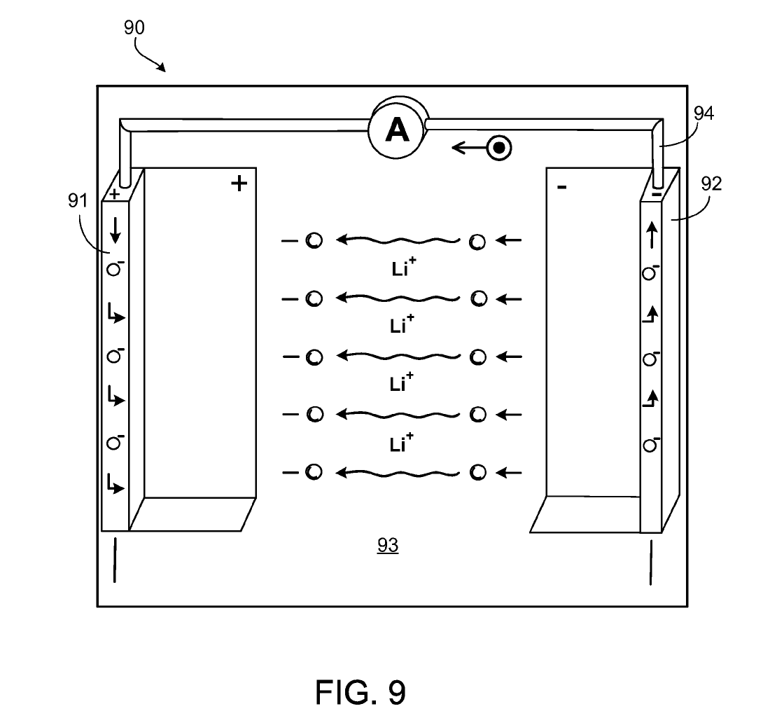

FIG. 9 shows a schematic view of a lithium ion battery 90. Lithium ion battery 90 includes anode 91, cathode 92, and electrolyte 93 surrounding the anode and the cathode. Conductor 94 forms an electrical connection between anode 91 and cathode 92. Anode 91 and cathode 92 are capable of reversible intercalation/insertion of lithium ions, and the electrolyte functions to transfer ions between the electrodes. When a lithium ion battery cell is charging, the lithium ions are extracted from the cathode and inserted into the anode; the reverse occurs when the lithium ion cells are discharging.

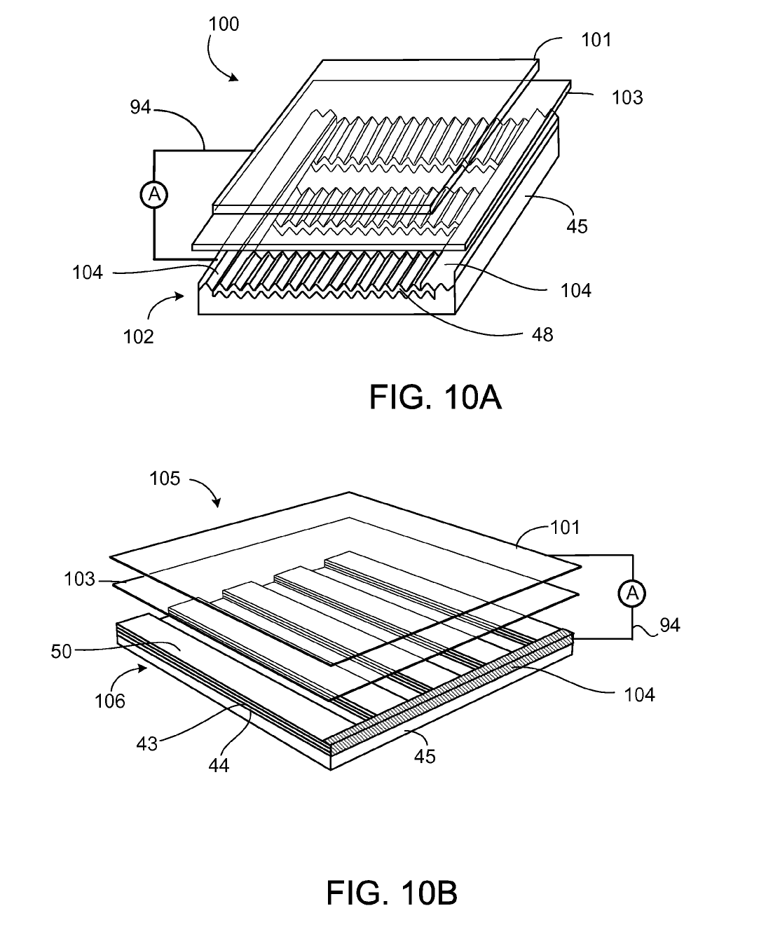

Lithium ion battery cells can be assembled using the flexible silicon anodes described herein. Examples of these cells include two-electrode HS-test cells (Hohsen Corp.) or two-electrode EQ-STC-24 splittable test cell (MTI Corp.) with flat or buckled flexible silicon anodes. FIG. 10A depicts an example of a lithium ion battery cell having a flexible silicon anode. Battery cell 100 has lithium cathode 101 and flexible silicon anode 102 with flexible substrate 45 and buckled silicon nanostructures 48. Cathode 101 and anode 102 are laminated together with separator 103. Separator 103 may be, for example, an ionic conductive polymer such as polypropylene (MTI Corp.) or polypropylene/polyethylene/polypropylene (Celgard 2340). 1 M LiPF₆ in ethylene carbonate:diethyl carbonate (EC:DEC) can be used as the electrolyte (not shown). Current collectors 104 are shown positioned along edges of the buckled silicon nanostructures. Conductor 94 forms an electrical connection between lithium cathode 101 and flexible silicon anode 102.

FIG. 10B depicts another example of a lithium ion battery cell. Battery cell 105 has lithium cathode 101, flexible silicon anode 106, separator 103, and current collector 104 (shown only on one side of the cell). Flexible silicon anode 105 includes flat silicon nanostructures 50 on flexible substrate 45, with current collectors 43 and adhesive layer 44 between the silicon nanostructures 50 and the flexible substrate. An adhesive layer may be present between silicon nanostructures 50 and current collectors 43, as shown in FIGS. 5A-5D. Conductor 94 forms an electrical connection between lithium cathode 101 and flexible silicon anode 102.

Battery cells 100 and 105 can be used in electrochemical characterizations to evaluate the performance of lithium ion batteries with flexible silicon anodes. It should be noted that, for lithium ion battery cells described herein, PDMS has been shown to be stable in the electrolyte in the absence of oxygen.

Microscopic techniques, such as optical and scanning electrical microscopy can be used to study morphology of buckled silicon layers associated with different electrochemical stages (e.g., fully charging and fully discharging stage). Specifically, a battery cell can be disassembled after a fully charged or discharged cycle, and the morphological changes can be evaluated at each stage and compared to the original buckling profile of the sample. Based on test results and the flexibility of buckled silicon layers, the buckled silicon layers remained intact (undamaged) after cell disassembling. In some cases, morphology of the buckled silicon layers can be measured after a number (e.g., 100) charge-discharge cycles to monitor fatigue properties of the buckled structures under the electrochemical process.

As described below, galvanostatic cycling experiments can account for the amount of the electrochemical energy storage and examine the cycling stability of the battery cells. Slow scan cyclic voltammetry (SSCV) can be used to identify details of the associated reactions during the lithium ion insertion and deinsertion reactions. The scan rate can be as slow as 20 μV/s using a potentiostat/galvanostat (Amtek PASTAK 2273), so that small electrochemical changes can be observed in the cyclic voltammetry (CV) profiles, which in turn can indicate roles played by the structural changes in the silicon layers. In some cases, the SSCV experiments are performed after each ten charge-discharge cycles in the battery cells set up with different flexible silicon anodes to monitor structural changes, if any, upon lithium ion insertion and deinsertion.

Electrochemical impedance spectroscopy (EIS) studies can be performed to evaluate the interfacial properties between the buckled silicon layers and electrolyte. For example lithium ion diffusion onto and inside the buckled silicon layers can be evaluated. EIS studies can be performed using the battery cells described herein, i.e., by applying a small perturbation voltage of 5 mV in the frequency range of 100 kHz to 10 mHz at different voltages during the discharge-charge cycle. An impedance measurement can be taken after equilibration at a chosen voltage for 1 hour. The analysis of the impedance spectra can be performed by equivalent circuit software provided by the manufacturer. Similar to SSCV experiments, EIS measurements are performed after each ten charge-discharge cycles, and the lithium ion diffusion coefficient after the first, tenth and twentieth (and so on) de-lithiation can be obtained to evaluate the reversible diffusion stability of lithium ions in the silicon layers.

Apart from monitoring morphological change of the buckled profiles using microscopy as well as lithium ion diffusion coefficient comparison upon cycling, the structural stability of the buckled silicon layers can be demonstrated by galvanostatic charge-discharge cyclability performance of the battery cells. Galvanostatic charge and discharge experiments can be performed using the battery cells described herein, by applying different charging-discharging rates from 0.1 to 100 (the C-rate can be calculated with respect to the theoretical capacity of silicon, 4,200 mAh/g), between 3.0 and 0.005 V using a battery testing unit (Arbin Instruments) to evaluate the storage capability and the cycling stability of the buckled silicon layers. In addition to evaluating the structural stability of the buckled silicon layers at different constant current conditions, the rate capability of the buckled silicon layers can be evaluated. The short diffusion distance (across the thickness of the silicon layers) for the lithium ions may bring about a high discharging rate (high-power density) in addition to the high-energy density fact of the silicon material. Also, the film-like buckled layers may be applicable for high current studies.

The buckled silicon is a film-like structure which can potentially provide several advantages compared with other types of electrodes. For instance, it is compatible with traditional battery design and may provide a better interfacial contact between the silicon nanostructures and current collectors without the use of binder materials, which is typically at the cost of the electrochemical performance of the battery as the binder is generally an inactive material. The nanoscale thickness can provide a short diffusion distance for lithium ions, which may promote a high discharging rate (high power density), in addition to the high-energy density of the silicon. The entire film (i.e., through the thickness of silicon layers) may participate in lithium ion storage, and the processing approach may be compatible with modern semiconductor techniques.

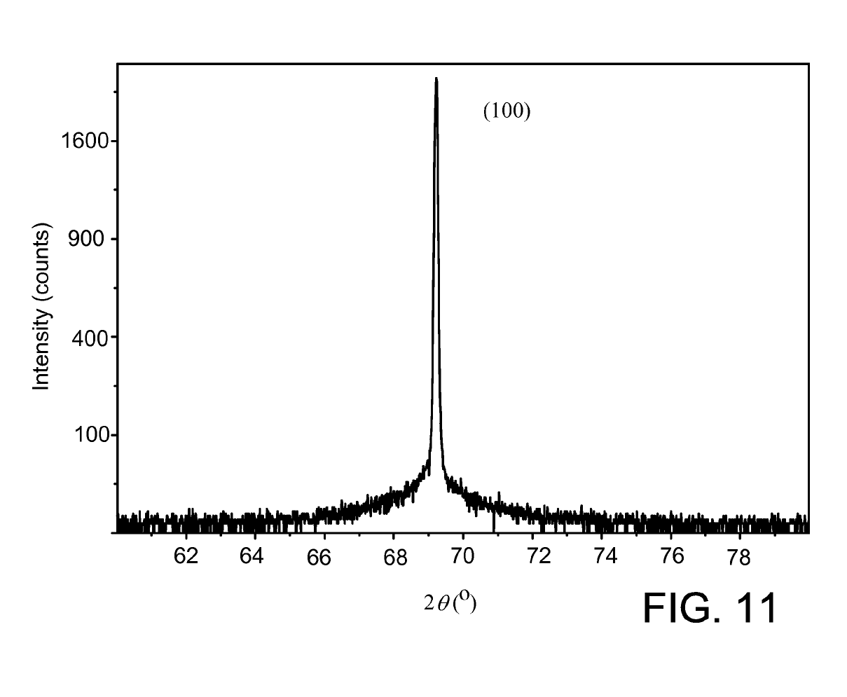

The silicon nanostructures described herein can be implemented using the device layer of SOI structures (Soitec USA, Inc.). In one example, a 100 nm thick crystalline (100) silicon is initially very lightly doped and has an electrical resistivity of 22.5 Ω·cm. To enhance the electrical conductivity, ion implantation (Innovion) is used to dope the silicon with boron ions to form p-type silicon. After a rapid thermal annealing in a nitrogen environment at 900° C. for 2 minutes, the electrical resistance of the doped silicon thin film is 1.5×10⁻³ Ω·cm. FIG. 11 shows results of an exemplary X-ray diffraction (XRD) measurement, indicating that the crystal structure of the silicon is not affected by ion implantation. The weight of the silicon anodes, 2.796 μg, was calculated by their geometry (100 nm thickness given by the SOI structure, 1.2×10⁷ μm² in-plane area defined by the photolithography mask, 20 silicon nanostructures with a width of 200 μm and a length of 3000 μm, and a silicon density of 2.329 g/cm³.

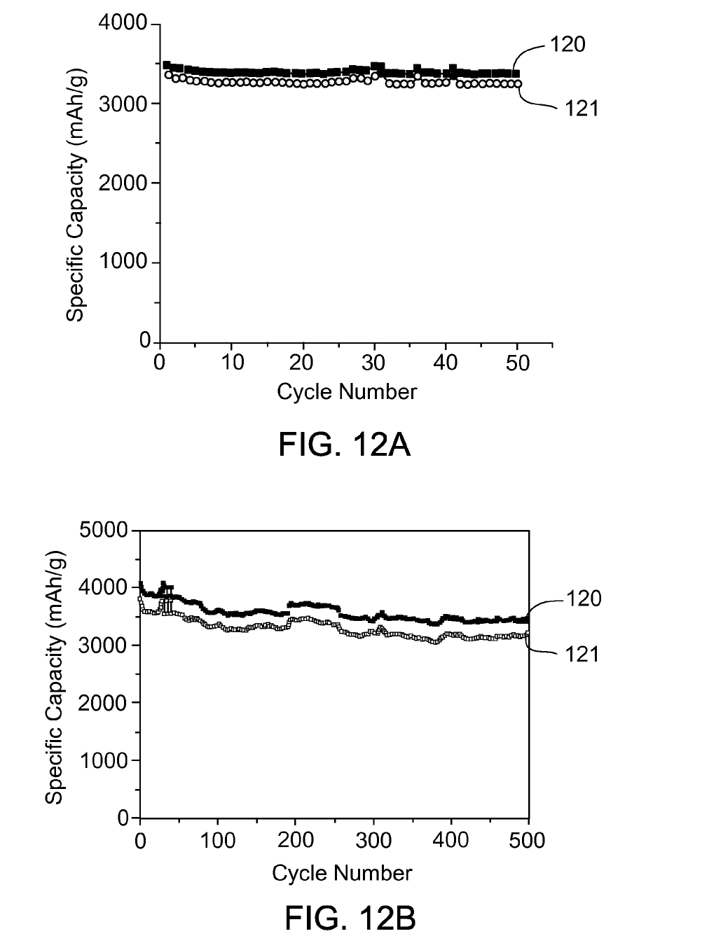

FIGS. 12A-12B show specific capacity vs. cycle number for battery cells depicted in FIG. 10A, with 100-nm thick buckled silicon nanostructures in the flexible silicon anode. The pre-strain on the PDMS substrates is 7% and the buckling wavelength is 17.2 μm. The current collector is 100-nm thick gold and the adhesive layer is 10-nm thick Cr₂O₃. The battery cells were assembled as shown in FIG. 10A and the electrochemical characterizations were conducted under the charge rate of 0.1C. As seen in FIGS. 12A and 12B, respectively, stable cycling performance is seen for up to 50 cycles and up to and 500 cycles, respectively. Plots 120 indicate charge capacity and plots 121 indicate discharge capacity.

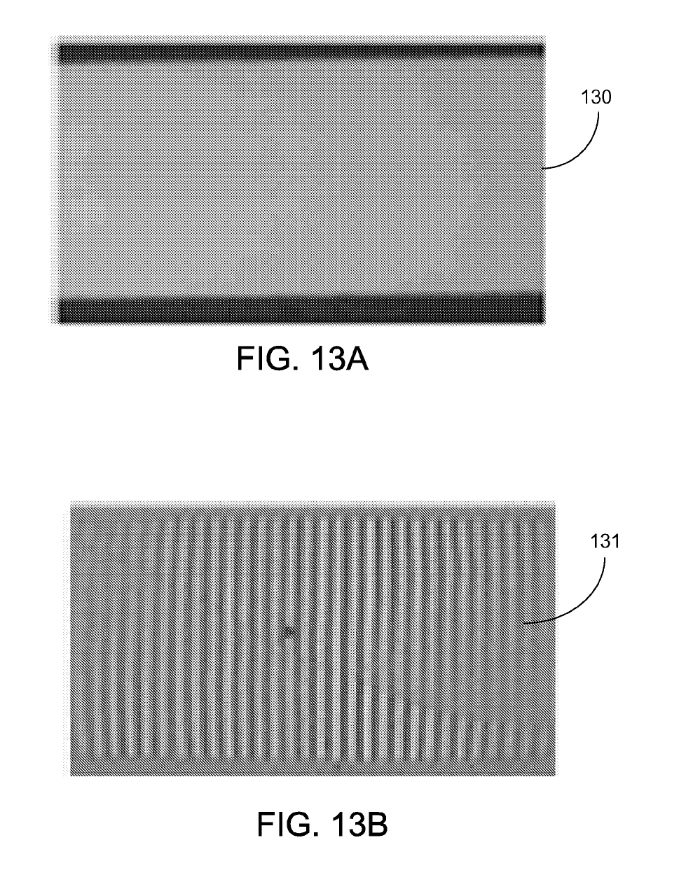

A similar test was conducted for 100-nm thick, 200-μm wide flat silicon nanostructures. FIG. 13A shows flat silicon nanoribbon 130 before the first charge cycle. FIG. 13B shows buckled silicon nanoribbon 131 after one charge.

These results indicate that the flexible silicon anodes can survive large volumetric strain and remain functional. Thus, the buckled silicon layers on flexible substrates can release the stress and relieve the failure of silicon in silicon anodes for lithium ion batteries.

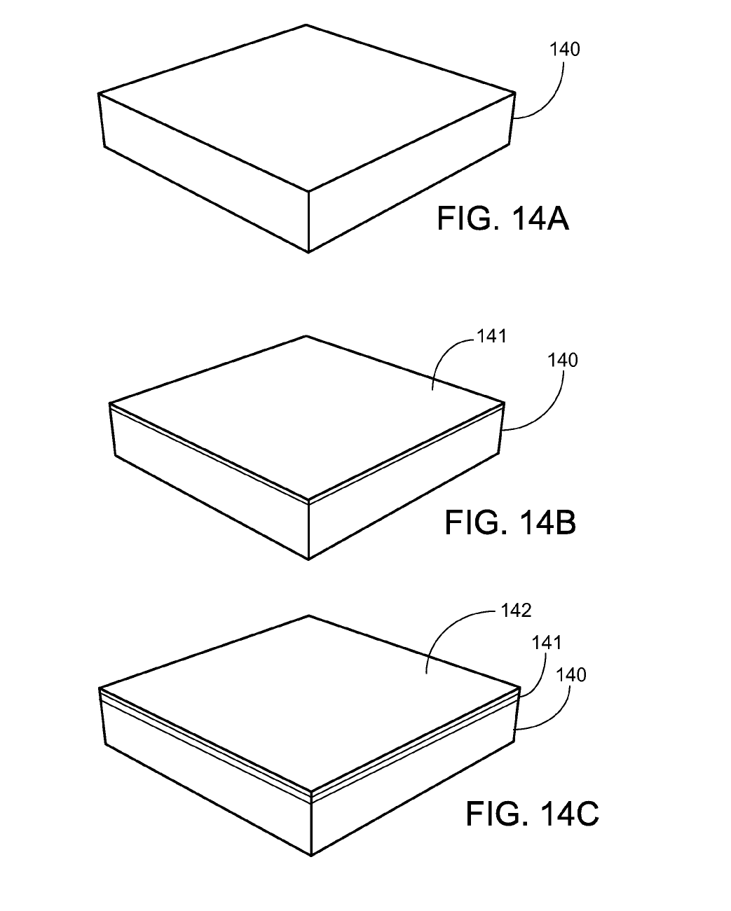

In some embodiments, substrates other than SOI structures with a crystalline silicon device layer can be used for the formation of silicon nanostructures. FIGS. 14A-14C show steps in a process to form a substrate that can be used to fabricate silicon nanostructures. FIG. 14A shows silicon substrate 140. A thin insulator layer (e.g, SiO₂) 141, shown in FIG. 14B, is then grown by thermal oxidation on silicon wafer 140. Insulator layer 141 can have a thickness, for example, between about a few nanometers to a few microns. The thickness of insulator layer 141 can be controlled by the duration of thermal oxidation. Then a polycrystalline silicon (poly-Si) or amorphous silicon (a-Si) layer 142, shown in FIG. 14C, is grown on top of insulator layer 141 by a low pressure chemical vapor deposition (LPCVD) method. Temperature and gas flow rate can be controlled to yield either poly-Si or a-Si. The microstructure (e.g., grain size) can be controlled by the deposition rate. The poly-Si or a-Si can be doped by dopant gases (e.g., diborane for p-type silicon) followed by annealing to form a low-cost poly-SOI or a-SOI structure.

Once the poly-SOI/a-SOI structure is fabricated and characterized, fabrication of flexible silicon anodes as described herein can be implemented, and silicon layers from the poly-SOI/a-SOI can be transferred to a flexible substrate. After etching out the insulator layer and adhering the poly-Si or a-Si to the flexible substrate, silicon wafers 140 can be reused for the same process.

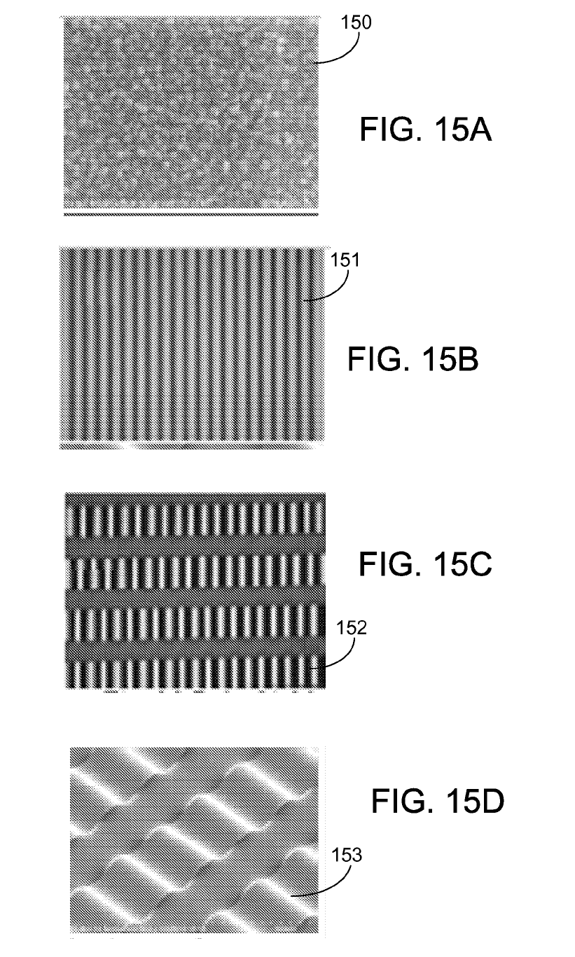

A poly-SOI structure (400 nm poly-silicon thin film/350 nm SiO₂/400 μm silicon) has been fabricated. FIG. 15A shows surface morphology of poly-SOI structure 150 using SEM, in which the surface roughness can be seen. FIG. 15B shows an image of flat poly-Si nanostructures 151 on a PDMS substrate. FIGS. 15C and 15D show images of buckled silicon nanostructures 152 and 153, respectively, on PDMS substrates.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Only a few implementations and examples are described and other implementations, enhancements and variations can be made based on what is described and illustrated in this application.

1. A silicon anode comprising:
a flexible substrate;
a layer of silicon adhered to the flexible substrate; and
a current collector in contact with the layer of silicon,
wherein a thickness of the silicon layer is 1 μm or less.

2. The silicon anode of claim 1, wherein the silicon layer comprises a multiplicity of unidirectional silicon nanostructures adhered to the surface of the flexible substrate, a multiplicity of bidirectional silicon nanostructures adhered to the surface of the flexible substrate, or a silicon membrane adhered to the surface of the flexible substrate.

3. The silicon anode of claim 1, wherein the silicon layer is planar.

4. The silicon anode of claim 1, wherein the silicon layer is buckled.

5. The silicon anode of claim 1, wherein the current collector comprises a layer of metal between the flexible substrate and the silicon layer.

6. The silicon anode of claim 1, wherein the current collector is formed over a portion of the silicon layer.

7. The silicon anode of claim 1, wherein a width or a length of the silicon layer is at least 100 or 1000 times the thickness of the silicon layer.

8. The silicon anode of claim 1, wherein the silicon layer is doped.

9. The silicon anode of claim 1, wherein the flexible substrate comprises poly(dimethylsiloxane).

10. The silicon anode of claim 1, wherein a thickness of the flexible substrate is at least 100 times or up to 1000 or 10,000 times the thickness of the silicon layer.

11. A lithium ion battery cell comprising:
a silicon anode comprising:
a flexible substrate;
a layer of silicon adhered to the flexible substrate, wherein a thickness of the silicon layer is 1 μm or less; and
a current collector in contact with the layer of silicon,
a lithium cathode;
a separator between the silicon anode and the lithium cathode;
an electrolyte in contact with the silicon anode and the lithium cathode; and
an electrical connection between the silicon anode and the lithium cathode.

12. A method of forming a silicon anode, the method comprising:
etching a silicon-on-insulator structure to form a silicon layer having a thickness of 1 μm or less on the silicon substrate;
treating the silicon layer;
contacting the treated silicon layer with a flexible substrate to adhere the treated silicon layer to the flexible substrate; and
separating the flexible substrate and the silicon substrate, thereby transferring the treated silicon layer from the silicon substrate to the flexible substrate to form a flexible silicon anode.

13. (canceled)

14. The method of claim 12, wherein etching the silicon-on-insulator structure comprises removing an insulator layer between the silicon layer and the silicon substrate.

15. The method of claim 12, wherein the silicon layer comprises a multiplicity of unidirectional silicon nanostructures, a multiplicity of bidirectional silicon nanostructures, or a silicon membrane.

16. (canceled)

17. The method of claim 12, wherein the flexible substrate comprises poly(dimethylsiloxane).

18. The method of claim 12, wherein treating the silicon layer comprises forming a current collector on the silicon layer and forming an adhesive layer on the current collector.

19. The method of claim 12, wherein treating the silicon layer comprises forming an adhesive layer on the silicon layer.

20. The method of claim 12, further comprising stretching the flexible substrate in at least one direction before contacting the treated silicon layer with the flexible substrate.

21. (canceled)

22. (canceled)

23. (canceled)

24. The method of claim 12, further comprising laminating the flexible silicon anode to a lithium cathode with a separator to form a lithium ion battery cell.

25. The method of claim 12, further comprising forming a current collector on the silicon anode such that current collector contacts the silicon layer, and laminating the silicon anode to a lithium cathode with a separator to form a lithium ion battery cell.
